(19) United States
(12) Patent Application Publication
(10) Pub. No.: US 2010/0058025 A1
(43) Pub. Date: Mar. 4, 2010

(54) METHOD, APPARATUS AND SOFTWARE PRODUCT FOR DISTRIBUTED ADDRESS-CHANNEL CALCULATOR FOR MULTI-CHANNEL MEMORY

(76) Inventors: Kimmo Kuusilinna, Tampere (FI); Jari Nikara, Tampere (FI); Tapio Hill, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/198,872

(22) Filed: Aug. 26, 2008

(51) Int. Cl. G06F 12/08; G06F 12/00

(52) U.S. Cl. 711/207; 711/206; 711/E12.001; 711/E12.058; 711/E12.059

(57) ABSTRACT

A method, apparatus, and computer program product are used for reading from a table that splits a plurality of physical addresses between a plurality of channels. One of the physical addresses is determined based at least partly on a virtual address used by an execution device such as the hardware environment, and based at least partly on information about a channel. Then, the physical address is provided to the execution device.

### FIELD OF THE INVENTION

The invention relates to wireless telecommunications, and more particularly multi-channel memory.

### BACKGROUND OF THE INVENTION

The currently predicted bandwidth requirement for multimedia-capable (high-end) mobile communication devices during the next several years is approximately 10 gigabytes per second (10 GB/s). This requirement is mainly driven by the needs of Motion Picture Experts Group Advanced Video Coding (MPEG4/AVC 1080p) at 30 frames per second (fps). The only known technology capable of delivering this bandwidth is multi-channel memory (MCMem). Multi-channel means that there are multiple (i.e. more than one) separate and parallel paths to execution memory (dynamic random access memory or DRAM) from which data can be accessed. Multi-channel differs from multi-port, so that in multi-port all the ports access the same physical memory, whereas in multi-channel the channels lead to physically different memory locations.

Multi-channel implementations have so far been relatively limited due to package input-output (I/O) pin requirements for the multiple channels. However, two contemporary technological trends are changing this situation. One contemporary trend is 3D die stacking. Die stacking, otherwise known as “chip stacking”, is a process of mounting multiple chips on top of each other within a single semiconductor package, and 3D die stacking may increase transistor density by vertically integrating two or more die with a dense, high-speed interface. Hundreds and later even thousands of connections can be manufactured between the dies. A second contemporary trend is towards serial interconnections that reduce the I/O pins in a single channel.

A memory management unit (MMU), or paged memory management unit (PMMU), is a computer hardware component responsible for handling accesses to memory requested by the central processing unit (CPU). The duties of the MMU include the following: translation of virtual addresses to physical addresses (e.g. as part of virtual memory management), memory protection, maintaining scatter-gather list, cache control, and bus arbitration. An operating system typically assigns a separate virtual address space to each program. MMUs divide the virtual address space into pages, a page being a block of contiguous virtual memory addresses whose size is (typically) 4 kilobytes. MMU translates virtual (also called “logical” or “linear”) page numbers to physical page numbers via a cross-reference known as a page table. A part of the page table is cached in a Translation Lookaside Buffer (TLB).

In a computer with virtual memory, the term “physical address” is often used to differentiate from a “virtual address”. In particular, in a computer utilizing an MMU to translate memory addresses, the virtual and physical address refer to address before and after MMU translation, respectively. Almost all implementations of virtual memory use page tables to translate the virtual addresses seen by the application program into physical addresses (also sometimes referred to as “real addresses”) used by the hardware to process instructions. Systems can have one page table for the whole system or a separate page table for each application. Paging is the process of saving inactive virtual memory pages to disk and restoring them to real memory when required.

When a CPU fetches an instruction located at a particular virtual address or, while executing an instruction, fetches data from a particular virtual address or stores data to a particular virtual address, the virtual address typically must be translated to the corresponding physical address. This is usually done by the MMU, which looks up the real address (from the page table) corresponding to a virtual address. If the page tables indicate that the virtual memory page is not currently in real memory, the hardware raises a page fault exception (special internal signal) which invokes the paging supervisor component of the operating system (see below).

If a continuous memory allocation from the virtual address space is larger than the largest available continuous physical address range, then the physical allocation must be formed from several memory ranges. This scatter-gather implementation is a development of the simpler page table arrangement that can only access continuous physical memory. Due to naturally occurring memory fragmentation while the device is used, the simpler implementation has an unfortunate tendency to run out of memory even if ample memory is theoretically free.

A page fault happens when, for example, a virtual page is accessed that does not have a physical page mapped to it. The operating system (OS) can use this information to protect the memory from errant programs accessing memory areas to which they should not have access.

A typical MMU works in a centralized environment that contains one master CPU and the OS running on it. In this configuration, the OS knows how the memory is allocated and can move the data and allocations around if necessary. This can be useful to form larger continuous physical memory areas and to put the unused memory areas into a power saving state. According to current application processing engine (APE) architecture found, if MMU-like functionality is found anywhere else than directly associated with the CPU, it is typically very limited in functionality (e.g. limited to scatter-gather functionality).

### SUMMARY OF THE INVENTION

The multi-channel memory architecture needs a way to determine which channel each address belongs to, and what exact address bits to use on that channel. An embodiment of the present invention adds a calculation block to the virtual-to-physical address translation for determining the aforementioned factors, and that additional block is a Distributed Address-Channel Calculator Apparatus. This addition integrates to the MMU.

The physical implementation of the Distributed Address-Channel Calculator Apparatus can be as simple as hardwired wire routing, but a preferred implementation is a look-up table defining what the address bits mean in terms of channels and addressed bits. Optionally, to support complex channel allocations and data interleaving, the selection of a correct look-up table row can be supported by including additional bits to the page table.

### BRIEF DESCRIPTION OF THE DRAWINGS

FIG. 1 shows an overview of the translation of virtual (linear/logical) addresses to physical addresses for a multi-channel memory architecture, according to an embodiment of the present invention.

FIG. 2 shows an implementation of the virtual to physical mapping process for multi-channel memory architecture, according to an embodiment of the present invention.

FIG. 3 shows an example of a multi-channel memory system with two channel clusters, according to an embodiment of the present invention.

FIG. 4 shows in tabular form an embodiment of an address-channel calculation according to an embodiment of the present invention.

FIG. 5 is a flow chart showing a method according to an embodiment of the present invention.

FIG. 6 is a block diagram of an embodiment of the present invention.

### DETAILED DESCRIPTION OF AN EMBODIMENT OF THE INVENTION

In the multi-channel memory environment, there are important issues that the conventional MMU does not adequately perform. A first problem with the conventional MMU is that, in addition to managing the physical address space, the channel allocation for addresses and between memory masters needs to be arranged. To maximize resource usage, the allocation should generally be dynamic. Dynamic means that physical memory regions can be allocated for processes and subsequently these allocations can be freed at run-time, making memory available for other processes.

A second problem with the conventional MMU is that the centralized environment with one master CPU and one OS is no longer valid for some modern wireless communication devices. The device contains multiple masters that are capable of independently generating memory accesses. Some examples are the main CPU, video subsystem, and graphics subsystem. Currently, there is no centrally supervised memory protection for the memory accesses from video and graphics subsystems.

A third problem with the conventional MMU is that, currently, large static memory allocations are performed at boot time for video and graphics buffers. The OS does not necessarily know which parts of these allocations are actually used and, therefore, cannot apply the most aggressive power management strategies to these regions.

Preferably, there is a multi-memory-master Application Processing Engine (APE) architecture where the MMU functionality is distributed among the memory masters. Alternatively, the MMU function could be centralized to reside between the System interconnect and the multi-channel memory subsystem.

The problems described above did not exist previously, because the memories have been single channel. In classical computer science, multi-channel memories have been used to a limited extent in standard computing machinery. A typical setup would be to direct even-numbered addresses to one channel, and to direct odd-numbered addresses to another channel. This requires almost no additional intelligence from the MMU. Also, more channels have been used following the same kind of logic. In all the related art implementations, the access to the memory system has been from a single point (master). This single point has been the enabling factor for conflict-free memory allocation and ensuring that memory accesses do not overlap.

The applications and the operating system can see the execution memory if they use paged memory, i.e. an MMU. A separate virtual address space is typically reserved for each application, and a mapping must exist between the virtual addresses and the actual physical memory locations. Memory allocations, and therefore the mappings, are done with a granularity of a frame. The frame size is fixed for a particular system and is usually four (4) kilobytes. The allocations need not be contiguous, which increases memory availability.

In a typical implementation of the virtual to physical address mapping process, the virtual address consists of two fields: Offset and Frame address. The Offset directly corresponds to the address within a frame and no conversion is made for it. That is, the Offset bits are the same in the virtual and in the Physical address. The Frame address, however, needs to be converted. The Frame address is matched against a Tag in the Page table (or a cached version of it, the TLB). If a match is found, the most significant bits of the Physical address come from the Page table line corresponding to the matched Tag.

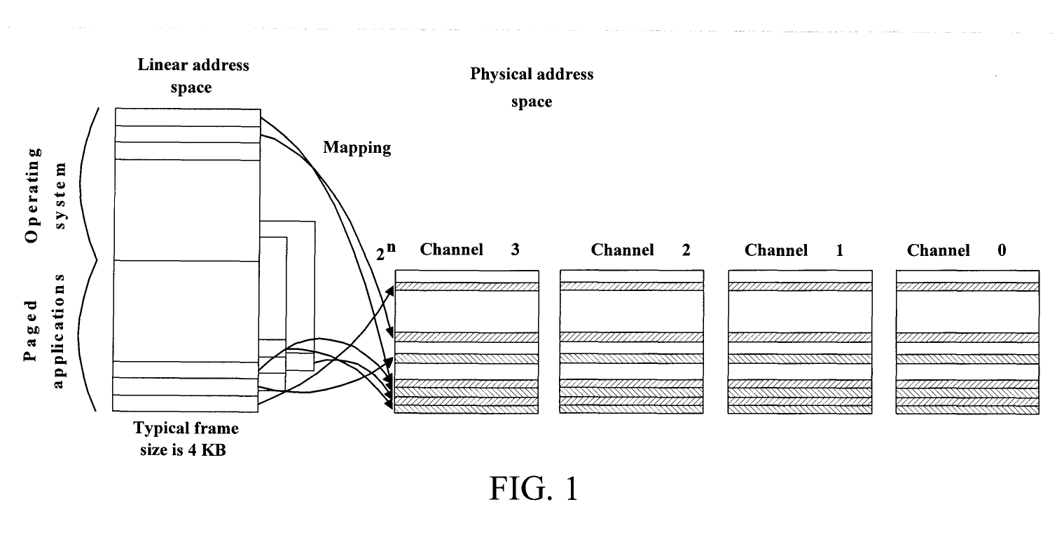

FIG. 1 provides an overview of the translation of virtual (linear/logical) addresses to physical addresses for a multi-channel memory architecture. According to FIG. 1, the physical address space is divided between four channels. The physical address space is always a contiguous range from 0 to 2ⁿ. The physical addresses are located on sequential channels beginning from Channel 0, then Channel 1, Channel 2, Channel 3, and then wrapping back to Channel 0, and so on. The granularity of this mapping is pre-selected and it amounts to the smallest possible interleaving granularity of the system. This granularity has the practical lower bound of the smallest amount of data that can be conveniently fetched from a single memory component. For example, the smallest amount of data that can be read from LPDDR2-S4 memory component is 4×32 bits=16 bytes. This way, a memory allocation always reserves physical memory from all the channels.

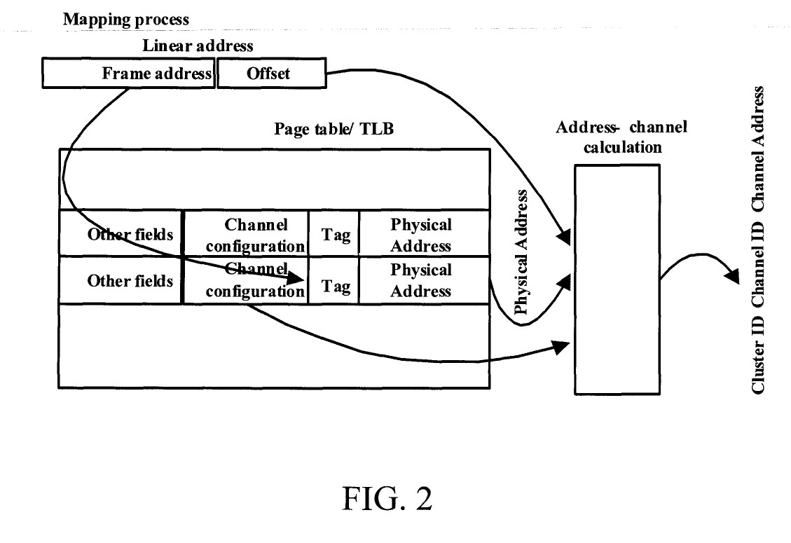

Compared to the related art, this arrangement splits the physical address space between multiple channels. Hence, a method of determining which address is located in which channel is needed. An apparatus for doing that, the Address-channel calculation, is depicted in FIG. 2, which shows an implementation of the virtual-to-physical mapping process for multi-channel memory architecture. The complexity of this block can vary greatly from extremely simple to very complex, depending upon the requirements of the system. In simple form, it uses a fixed part of the physical address to determine which address belongs to which channel. An optional, more advanced, situation is depicted in FIG. 2. As in the related art, the correct line from the Page table and the upper bits of the Physical address are selected with the aid of the Frame address and the Tag. However, now there is an extra interpretation step (Address-channel calculation) to identify the correct Channel Cluster, Channel, and the address that is finally used in the selected Channel.

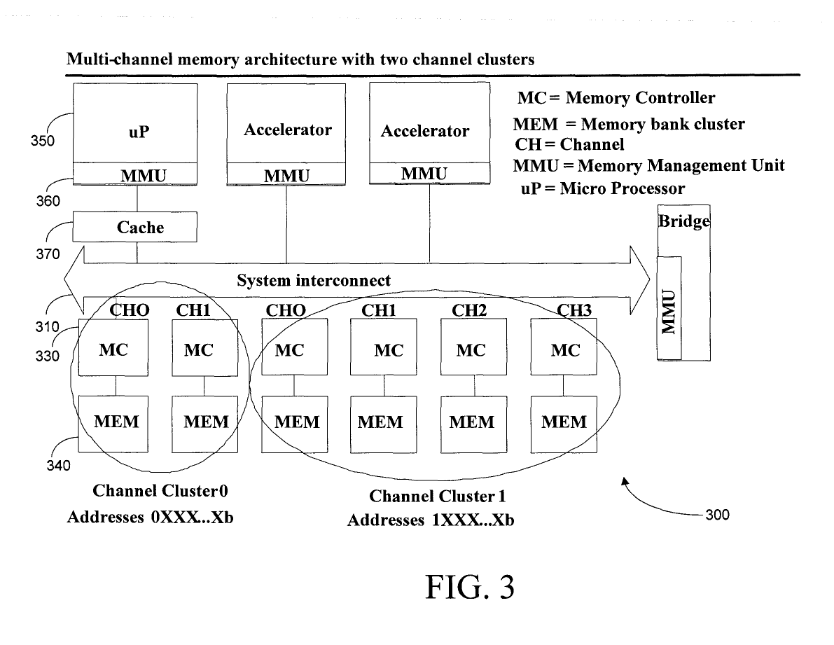

With Channel Cluster, the physical address space can be divided between different multi-channel or single-channel memory subsystems. For example, if there are two separate four-channel memory subsystems, the most significant bit of the physical address can be used to distinguish between the subsystems. Another example with two Channel Clusters is depicted in FIG. 3, which shows an example of a multi-channel memory system 300 with two channel clusters, having a system interconnect 310, memory controllers 330 and memory bank cluster 340. The microprocessor core subsystem includes microprocessor 350, MMU 360, and cache 370.

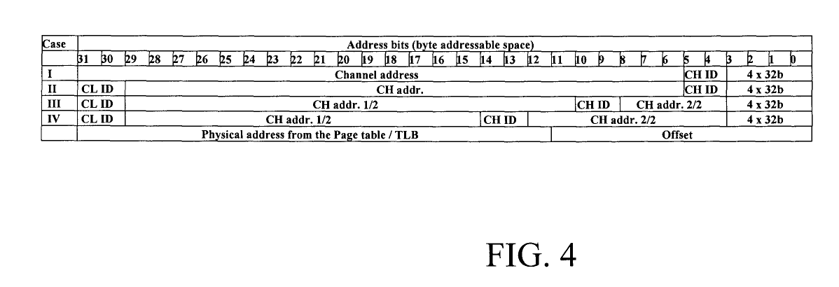

Memory allocations may not cross Channel Cluster boundaries. That is, a memory allocation reserves physical memory locations from all the memory components in a single Channel Cluster. Furthermore, a memory allocation may not allocate memory from multiple Channel Clusters. If the system only contains one Channel Cluster, it does not need addressing or bits, as shown in the table of FIG. 4, Case I. The remaining cases (II-IV) assume a system with four Channel Clusters, so that the two topmost bits are reserved for this selection. The Table in FIG. 4 shows exemplary implementations of the Address-channel calculation for a 32-bit Physical address.

In FIG. 4, CH ID=Channel ID, CH addr.=Channel address, and CL ID=Channel cluster ID. In all four of the cases shown in FIG. 4, the four lowest bits (numbered 0-4) are not used at this stage, since they correspond to addresses that are too detailed to be accessed with this arrangement. Both Case I and Case II use the system default interleaving scheme. If the MMU only supports one Physical address layout and the channel selection algorithm can be hardwired to the Address-channel calculation, the Channel configuration information in FIG. 2 is unnecessary. However, if a selection of different memory subsystem usage models (e.g. the Cases in FIG. 4) is desired or the channel selection algorithm is complex, the Channel configuration information is needed. For instance, if a system that supports the four Cases in FIG. 4 needs to be built, it is necessary to reserve two bits for the Channel configuration in the Page table/TLB.

Note that the physical memory allocation in this exemplary embodiment always happens with Case I or Case II model. The use of Case III requires a contiguous memory allocation of no less than 2 KB. Likewise, the use of Case IV requires a contiguous memory allocation of at least 32 KB. This way, the channel allocation style can change within a contiguous allocation.

Without some channel allocation scheme, the multi-channel memory architecture does not work at all and the present embodiment of the invention describes one solution to the problem. If only the Case I or Case II from FIG. 4 are implemented system-wide, then the added functionality consists of routing bits to appropriate locations. Conversely, the solution provided by this embodiment of the invention also scales to more complex implementations that can be used, for example, to optimize memory access times through the use of application specific data interleaving, or enable the use of aggressive power down modes for parts of the memory since now the MMUs know which channels and parts of the memory are actually used.

Since all memory allocated using the described method can be also freed at run-time, the memory usage is dynamic. This increases allocation efficiency which means that the device is less likely to run out of memory. The distributed nature of the invention means that it scales well both to accommodate a large number of memory masters and wide & complex memory subsystems. Particularly, the Channel Cluster-mechanism enables efficient utilization of a large number of channels. The system-wide use of MMUs also provides a security mechanism by which running processes can be prevented from accessing memory areas that are not designated for their use.

Several further embodiments of the present invention will now be described, merely to illustrate how the invention may be implemented, and without limiting the scope or coverage of what is described elsewhere in this application.

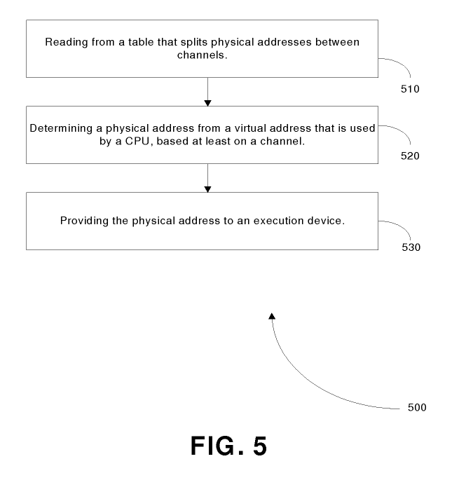

As shown in FIG. 5, the present invention includes a first aspect that is a method 500 comprising: reading 510 from a table that splits a plurality of physical addresses between a plurality of channels; determining 520 one of the physical addresses based at least partly on a virtual address used by an execution device and based at least partly on information identifying a subset of said plurality of channels; and, providing 530 said one of the physical addresses to the execution device.

The present invention includes a second aspect that is the method of the first aspect, wherein said information identifying a subset of said plurality of channels is obtained from the virtual address, and identifies a particular channel cluster or channel.

The present invention includes a third aspect that is the method of the first aspect, wherein said table is a page table or translation lookaside buffer, and wherein said determining one of the physical addresses is performed using said page table or translation lookaside buffer.

The present invention includes a fourth aspect that is the method of the first aspect, wherein said method is performed by a memory management unit or component in order to translate virtual addresses to physical addresses.

The present invention includes a fifth aspect that is the method of the first aspect, wherein said channels comprise separate paths leading to a plurality of separate memory locations in a dynamic random access memory.

The present invention includes a sixth aspect that is the method of the first aspect, wherein said determining comprises matching a frame address of the virtual address against a tag in the table, wherein said table is dynamic instead of static, and wherein said subset of said plurality of channels is a single channel.

The present invention includes a seventh aspect that is a computer program product comprising a computer readable medium having code stored therein; the code, when run by a processor, adapted for reading from a table that splits a plurality of physical addresses between a plurality of channels; determining one of the physical addresses based at least partly on a virtual address used by an execution device and based at least partly on information identifying a subset of said plurality of channels; and, providing said one of the physical addresses to the execution device.

The present invention includes an eighth aspect that is the computer program product of the seventh aspect, wherein said information identifying a subset of said plurality of channels is obtained from the virtual address, and identifies a particular channel cluster or channel.

The present invention includes a ninth aspect that is the computer program product of the eighth aspect, wherein said table is a page table or translation lookaside buffer, and wherein said determining one of the physical addresses is performed using said page table or translation lookaside buffer.

The present invention includes a tenth aspect that is the computer program product of the eighth aspect, wherein said method is performed by a memory management unit or component in order to translate virtual addresses to physical addresses.

The present invention includes an eleventh aspect that is the computer program product of the eighth aspect, wherein said channels comprise separate paths leading to a plurality of separate memory locations in a dynamic random access memory.

The present invention includes a twelfth aspect that is the computer program product of the eighth aspect, wherein said determining comprises matching a frame address of the virtual address against a tag in the table, wherein said table is dynamic instead of static, and wherein said subset of said plurality of channels is a single channel.

The present invention includes a thirteenth aspect that is an apparatus comprising: means for reading from a table that splits a plurality of physical addresses between a plurality of channels; means for determining one of the physical addresses based at least partly on a virtual address used by an execution device and based at least partly on information identifying a subset of said plurality of channels; and, means for providing said one of the physical addresses to the execution device.

The present invention includes a fourteenth aspect that is the apparatus of the thirteenth aspect, wherein said information identifying a subset of said plurality of channels is obtained from the virtual address, and identifies a particular channel cluster or channel.

The present invention includes a fifteenth aspect that is the apparatus of the thirteenth aspect, wherein said table is a page table or translation lookaside buffer, and wherein said means for determining one of the physical addresses utilizes said page table or translation lookaside buffer.

The present invention includes a sixteenth aspect that is the apparatus of the thirteenth aspect, wherein said apparatus is comprised by a memory management unit or component in order to translate virtual addresses to physical addresses.

The present invention includes a seventeenth aspect that is the apparatus of the thirteenth aspect, wherein said channels comprise separate paths leading to a plurality of separate memory locations in a dynamic random access memory.

The present invention includes an eighteenth aspect that is the apparatus of the thirteenth aspect, wherein said means for determining comprises means for matching a frame address of the virtual address against a tag in the table, wherein said table is dynamic instead of static, and wherein said subset of said plurality of channels is a single channel.

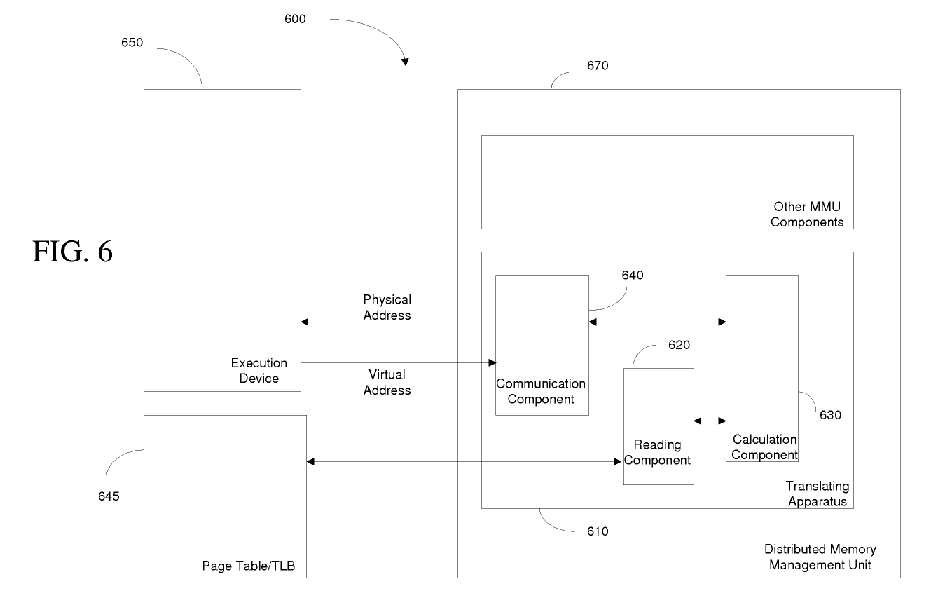

As shown in FIG. 6, the present invention includes a nineteenth aspect that is an apparatus 610 comprising: a reading component 620 configured to read from a table 645 that splits a plurality of physical addresses between a plurality of channels; a calculating component 630 configured to determine one of the physical addresses based at least partly on a virtual address used by an execution device 650 and based at least partly on information identifying a subset of said plurality of channels; and, a communication component 640 configured to provide said one of the physical addresses to the execution device. The MMU 670 is part of a microprocessor (not shown), and the execution device 650 may be located either within the microprocessor, or external to the microprocessor. The execution device may, for example, represent the containing hardware environment, or a part of that environment.

The present invention includes a twentieth aspect that is the apparatus of the nineteenth aspect, wherein said information identifying a subset of said plurality of channels is obtained from the virtual address, and identifies a particular channel cluster or channel.

The present invention includes a twenty-first aspect that is the apparatus of the nineteenth aspect, wherein said table is a page table or translation lookaside buffer, and wherein said means for determining one of the physical addresses utilizes said page table or translation lookaside buffer.

The present invention includes a twenty-second aspect that is the apparatus of the nineteenth aspect, wherein said apparatus is comprised by a memory management unit or component 670 in order to translate virtual addresses to physical addresses.

The present invention includes a twenty-third aspect that is the apparatus of the nineteenth aspect, wherein said channels comprise separate paths leading to a plurality of separate memory locations in a dynamic random access memory.

The present invention includes a twenty-fourth aspect that is the apparatus of the nineteenth aspect, wherein said calculating component comprises a matching component configured to match a frame address of the virtual address against a tag in the table, wherein said table is dynamic instead of static, and wherein said subset of said plurality of channels is a single channel.

The embodiments described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor comprising a single processing unit, multiple processing units capable of parallel operation, or the CPU can be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, similar to CPU, memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, network element, user equipment, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method comprising:
reading from a table that splits a plurality of physical addresses between a plurality of channels;
determining one of the physical addresses based at least partly on a virtual address used by an execution device and based at least partly on information identifying a subset of said plurality of channels; and,
providing said one of the physical addresses to the execution device.

2. The method of claim 1, wherein said information identifying a subset of said plurality of channels is obtained from the virtual address, and identifies a particular channel cluster or channel.

3. The method of claim 1, wherein said table is a page table or translation lookaside buffer, and wherein said determining one of the physical addresses is performed using said page table or translation lookaside buffer.

4. The method of claim 1, wherein said method is performed by a memory management unit or component in order to translate virtual addresses to physical addresses.

5. The method of claim 1, wherein said channels comprise separate paths leading to a plurality of separate memory locations in a dynamic random access memory.

6. The method of claim 1, wherein said determining comprises matching a frame address of the virtual address against a tag in the table, wherein said table is dynamic instead of static, and wherein said subset of said plurality of channels is a single channel.

7. A computer program product comprising a computer readable medium having code stored therein; the code, when run by a processor, adapted for:
reading from a table that splits a plurality of physical addresses between a plurality of channels;
determining one of the physical addresses based at least partly on a virtual address used by an execution device and based at least partly on information identifying a subset of said plurality of channels; and,
providing said one of the physical addresses to the execution device.

8. The computer program product of claim 7, wherein said information identifying a subset of said plurality of channels is obtained from the virtual address, and identifies a particular channel cluster or channel.

9. The computer program product of claim 8, wherein said table is a page table or translation lookaside buffer, and wherein said determining one of the physical addresses is performed using said page table or translation lookaside buffer.

10. The computer program product of claim 8, wherein said method is performed by a memory management unit or component in order to translate virtual addresses to physical addresses.

11. The computer program product of claim 8, wherein said channels comprise separate paths leading to a plurality of separate memory locations in a dynamic random access memory.

12. The computer program product of claim 8, wherein said determining comprises matching a frame address of the virtual address against a tag in the table, wherein said table is dynamic instead of static, and wherein said subset of said plurality of channels is a single channel.

13. An apparatus comprising:
means for reading from a table that splits a plurality of physical addresses between a plurality of channels;
means for determining one of the physical addresses based at least partly on a virtual address used by an execution device and based at least partly on information identifying a subset of said plurality of channels; and,
means for providing said one of the physical addresses to the execution device.

14. An apparatus comprising:
a reading component configured to read from a table that splits a plurality of physical addresses between a plurality of channels;
a calculating component configured to determine one of the physical addresses based at least partly on a virtual address used by an execution device and based at least partly on information identifying a subset of said plurality of channels; and,
a communication component configured to provide said one of the physical addresses to the execution device.

15. The apparatus of claim 14, wherein said information identifying a subset of said plurality of channels is obtained from the virtual address, and identifies a particular channel cluster or channel.

16. The apparatus of claim 14, wherein said table is a page table or translation lookaside buffer, and wherein said calculating component utilizes said page table or said translation lookaside buffer.

17. The apparatus of claim 14, wherein said apparatus is comprised by a memory management unit, or by a component of a memory management unit, in order to translate virtual addresses to physical addresses.

18. The apparatus of claim 14, wherein said channels comprise separate paths leading to a plurality of separate memory locations in a dynamic random access memory.

19. The apparatus of claim 14,
wherein said calculating component comprises a matching component configured to match a frame address of the virtual address against a tag in the table,
wherein said table is dynamic instead of static, and
wherein said subset of said plurality of channels is a single channel.
